(19) United States
(12) Patent Application Publication
(10) Pub. No.: US 2026/0342263 A1
(43) Pub. Date: Oct. 29, 2026

(54) APPARATUS AND METHOD FOR AUTOMATICALLY SUPPRESSING RESONANCE OF SERVO SYSTEM

(71) Applicants: SEOUL NATIONAL UNIVERSITY R&DB FOUNDATION, Seoul (KR); RS AUTOMATION CO., LTD., Pyeongtaek-si (KR)

(72) Inventors: Dong Il Cho, Seoul (KR); Young-Seok Kim, Seoul (KR); Tae-Ho Oh, Busan (KR); Sang-Hoon Lee, Seongnam-si (KR)

(21) Appl. No.: 19/106,998

(22) PCT Filed: Sep. 1, 2022
(86) PCT No.: PCT/KR2022/013136

§ 371 Date: Apr. 4, 2025

(30) Foreign Application Priority Data
Aug. 31, 2022 (KR) 10-2022-0110246

(51) Int. Cl. H02P 27/04; H02P 29/40; H02P 29/50

(52) U.S. Cl. CPC H02P 27/04; H02P 29/40; H02P 29/50

(57) ABSTRACT

This apparatus for suppressing resonance of a servo system comprises a resonance suppressing unit which includes: an amplitude estimator for outputting an amplitude estimation value that is a value obtained by estimating an amplitude of generated resonance from a current command received from a servo controller; and a frequency estimator for outputting an estimated frequency by estimating, in real time, a frequency of the generated resonance from the current command by using the amplitude estimation value, and which senses and determines resonance of the servo system on the basis of the current command and the estimated frequency and suppresses resonance. Accordingly, in a situation in which resonance of various amplitudes occurs in a servo system, the resonance of various amplitudes can be quickly estimated to respond thereto.

### TECHNICAL FIELD

The present invention relates to a method of automatically suppressing resonance of a servo system using an amplitude estimator and a frequency estimator, and more specifically, to a technology for automatically sensing and suppressing the resonance generated in the servo system by using a frequency estimator that uses the output of an amplitude estimator.

### DESCRIPTION OF NATIONAL SUPPORT RESEARCH AND DEVELOPMENT

This application has been made with the support of the Ministry of Small and Medium Enterprises and Startups World Class 300 (WC300) project (Robot Motion Control Solution for Flexible Response of Smart Machines/Collaborative Robots, Project Unique No.: 1425139888, Detailed Project No.: S2563339).

### BACKGROUND ART

A method of applying a notch filter to an output current command is being widely used as a method of suppressing the resonance phenomenon of a servo system. A notch filter is a filter that outputs a signal with components in a specific frequency band removed from an input signal. By using a notch filter to remove the frequency components that cause resonance from the current command, the resonance phenomenon of the servo system can be suppressed.

FIG. 1 is a block diagram of a servo system according to the related art. With reference to FIG. 1, the conventional servo system includes a control unit and a load unit. The control unit includes a servo controller, a filter unit, and a current controller. The load unit includes a motor, a load, and an encoder. In an exemplary embodiment, the load unit may be a plant. The servo controller generates a current command (control input) to control the motor of the load unit. The control input of the servo controller passes through the filter unit, which includes filters such as a low-pass filter for noise removal and a notch filter for removing signals in a specific frequency band. The current controller supplies a drive current to the motor corresponding to the control input that has passed through the filter unit. The encoder measures the state of the driven load and provides feedback information to the controller as feedback.

The servo controller refers to the received feedback during subsequent motor control. Here, the feedback information may be generated based on the angular displacement, but is not limited thereto, it may be information generated based on the angular displacement (angular position) and/or angular velocity of a control target. The specific configuration and operation method of the current controller, motor, and encoder are well known in the art, and thus a detailed description thereof is omitted here.

The method of suppressing resonance described above requires knowing the frequency characteristics of the system. To this end, a method widely used in the related art is to apply a sinusoidal signal to the system and acquire the frequency characteristics of the system through frequency analysis of the input and output. However, since the frequency characteristics are difficult to acquire in real time, there is a problem that makes it difficult to apply the method of suppressing resonance in real time.

To overcome this problem, a method of suppressing resonance in a servo system using an adaptive notch filter and a fixed notch filter has been proposed (Patent Document 1 and Patent Document 2 of the Documents of the Related art). The method described above is a method of detecting the resonant component of the system in real time, estimating the resonance frequency using a frequency estimator, and then setting the estimated frequency as the notch frequency of the adaptive notch filter to cope with the resonance frequency of the system, which can change depending on the operating conditions, in real time.

The method determines whether resonance suppression is determined when the adaptive notch filter is applied, and when resonance is suppressed by the application of the adaptive notch filter, sets the notch frequency of the adaptive notch filter to the notch frequency of the fixed notch filter and fixes it. In addition, when a plurality of fixed notch filters are required, the fixed notch filter for suppressing the resonance with the smaller size can be replaced with the fixed notch filter for suppressing the resonance with the larger size by comparing the sizes of the resonances. The method can suppress resonance in real time without acquiring the frequency characteristics of the plant, providing significant convenience to the user.

Meanwhile, conventional frequency estimators have a characteristic where the estimation velocity is proportional to the difference between the estimated frequency, which is the output value of the frequency estimator, and the frequency of the input signal, as well as the magnitude (amplitude) of the input signal (Non-Patent Document 1 of the Documents of the Related art). The frequency estimator is designed so that the velocity at which it estimates the frequency does not fluctuate significantly depending on the frequency band of the input signal, and has been applied to the method of suppressing resonance in a servo system that uses an adaptive notch filter and a fixed notch filter, to widely have been used for estimating the resonance frequency in industrial servo systems (applied to D8 series and CSD7 series of RS Automation Co., Ltd.).

However, the frequency estimator has the disadvantage that the frequency estimation velocity varies depending on the magnitude of the input signal. Therefore, since the estimation velocity slows down when the magnitude of the input signal is small, there is a disadvantage that when a small resonance is generated in the actual servo system, the frequency of the corresponding resonance is estimated slowly.

### DOCUMENTS OF RELATED ART

(Patent Document 1) KR 10-1757267 B1

(Patent Document 2) KR 10-1708739 B1

(Non-patent Document 1) W. Bahn, T. Kim, S. Lee, and D. Cho, “Resonant frequency estimation for adaptive notch filters in industrial servo systems,” Mechatronics, vol. 41, pp. 45-57, 2017.

### DISCLOSURE

### Technical Problem

The present invention has been made in an effort to solve the aforementioned problems, and provides an apparatus for suppressing resonance in a servo system that enables the fast estimation of resonances with various amplitudes and allowing the servo system to respond accordingly, by using the output of an amplitude estimator in a frequency estimator to alleviate the proportional relationship between the amplitude of the input signal and the estimation velocity of the frequency estimator.

Another object of the present invention is to provide a method of suppressing resonance in a servo system using the apparatus.

Yet another object of the present invention is to provide a computer program stored on a medium to execute the method of suppressing resonance in the servo system.

### Technical Solution

To achieve an object of the present invention described above, there is provided an apparatus for suppressing resonance of a servo system, according to an embodiment. The apparatus includes a resonance suppressing unit: the resonance suppressing unit comprises an amplitude estimator configured to output an amplitude estimation value, the amplitude estimation value being a value obtained by estimating an amplitude of resonance generated from a current command received from a servo controller; and a frequency estimator configured to estimate, in real time, a frequency of the resonance generated from the current command using the amplitude estimation value, and to output an estimated frequency, wherein the resonance suppressing unit is configured to sense, determine, and suppress resonance in the servo system based on the current command and the estimated frequency.

In the embodiment of the present invention, the amplitude estimator may estimate the amplitude of the resonance generated from the current command by using at least one of an adaptive filter state of the frequency estimator, an estimated frequency of previous samples, the current command, or statistics of the current command.

In the embodiment of the present invention, the frequency estimator may estimate the frequency of the current command, which is an input signal, by using at least one of the current command, the amplitude estimation value, an adaptive filter state, or an estimated frequency of previous samples.

In the embodiment of the present invention, the frequency estimator may divide a small amount of change in the estimated frequency by the amplitude estimation value and integrate the divided value to output an estimated frequency.

In the embodiment of the present invention, the frequency estimator may divide the small amount of change in the estimated frequency by a specific threshold value when the amplitude estimation value is equal to or less than the specific threshold, and divide the small amount of change in the estimated frequency by the amplitude estimation value when the amplitude estimation value exceeds the specific threshold value.

In the embodiment of the present invention, the resonance suppressing unit may further include at least one of a filter unit or a resonance sensing and determining unit.

In the embodiment of the present invention, the filter unit may further include an adaptive notch filter and a plurality of fixed notch filters that filter the current command using the estimated frequency as a notch frequency, and the fixed notch filter may use parameters of the adaptive notch filter, including the notch frequency, as filter parameters of the fixed notch filter when resonance suppression is confirmed with the adaptive notch filter, and fix values of the filter parameters of the fixed notch filter.

In the embodiment of the present invention, the resonance sensing and determining unit may determine whether the resonance of the servo system is generated, a magnitude of the resonance, and whether the resonance is suppressed by using the current command, and then determine whether to use an adaptive notch filter, whether to switch parameters to a fixed notch filter, and when a plurality of fixed notch filters are all in use and a new resonance is generated, compare a magnitude of the newly generated resonance with resonance magnitudes before each fixed notch filter is applied to determine whether to replace the fixed notch filter.

To achieve another object of the present invention described above, there is provided a method of suppressing resonance of a servo system, according to an embodiment. The method includes: an amplitude estimation step of outputting an amplitude estimation value, which is an value obtained by estimating an amplitude of resonance generated from a current command received from a servo controller; a frequency estimation step of estimating a frequency of the resonance generated from the current command in real time to output an estimated frequency by using the amplitude estimation value; and a resonance suppressing step of sensing, determining, and suppressing resonance of the servo system based on the current command and the estimated frequency.

In the embodiment of the present invention, the amplitude estimation step may include estimating the amplitude of the resonance generated from the current command by using at least one of an adaptive filter state, an estimated frequency of previous samples, the current command, or statistics of the current command.

In the embodiment of the present invention, the frequency estimation step may include estimating the frequency of the current command, which is an input signal, by using at least one of the current command, the amplitude estimation value, an adaptive filter state, or an estimated frequency of previous samples.

In the embodiment of the present invention, the frequency estimation step may further include dividing a small amount of change in the estimated frequency by the amplitude estimation value and integrates the divided value to output an estimated frequency.

In the embodiment of the present invention, the frequency estimation step may include dividing the small amount of change in the estimated frequency by a specific threshold value when the amplitude estimation value is equal to or less than the specific threshold, and dividing the small amount of change in the estimated frequency by the amplitude estimation value when the amplitude estimation value exceeds the specific threshold value.

In the embodiment of the present invention, the resonance suppressing step may further include at least one of a filtering step or a resonance sensing and determining step.

In the embodiment of the present invention, the filtering step may include filtering the current command using an adaptive notch filter and a plurality of fixed notch filters, with the estimated frequency being used as a notch frequency, and the fixed notch filter may use parameters of the adaptive notch filter, including the notch frequency, as filter parameters of the fixed notch filter when resonance suppression is confirmed with the adaptive notch filter, and fix values of the filter parameters of the fixed notch filter.

In the embodiment of the present invention, the resonance sensing and determining step may include: determining whether the resonance of the servo system is generated, a magnitude of the resonance, and whether the resonance is suppressed by using the current command; and determining whether to use an adaptive notch filter, whether to switch parameters to a fixed notch filter; and determining whether to replace the fixed notch filter by comparing a magnitude of a newly generated resonance with resonance magnitudes before each fixed notch filter is applied when a plurality of fixed notch filters are all in use and the new resonance is generated.

To achieve yet another object of the present invention described above, there is provided a computer program, according to an embodiment. The computer program is stored on a medium to execute the method of suppressing resonance of the servo system, in combination with hardware.

### Advantageous Effects

According to embodiments of the present invention, in a situation where resonances of various amplitudes are generated in a servo system, the amplitude estimator and frequency estimator can be used to quickly estimate and respond to resonances of various amplitudes.

### DESCRIPTION OF DRAWINGS

FIG. 1 is a block diagram of a servo system according to the related art.

FIG. 2 is a block diagram of a servo system according to an embodiment of the present invention.

FIG. 3 is a block diagram illustrating an example of the filter unit in FIG. 2.

FIG. 4 is a flowchart illustrating a method of automatically suppressing resonance of a servo system according to an embodiment of the present invention.

FIG. 5 is a flowchart illustrating the step of estimating the frequency in real time in FIG. 4.

### MODE FOR DISCLOSURE

The following detailed description of the present invention will be made with reference to the accompanying drawings illustrating specific exemplary embodiments for carrying out the present invention. These embodiments will be described in detail enough to carry out the present invention by those skilled in the art. It should be understood that various embodiments of the present invention are different from one another but need not be mutually exclusive. For example, particular shapes, structures, and characteristics described herein in respect to an embodiment can be implemented in other embodiments without departing from the spirit and scope of the present invention. In addition, it should be understood that the position or arrangement of each constituent element in the respective disclosed embodiments may be changed without departing from the spirit and scope of the present invention. Therefore, the following detailed description is not intended to limit the present invention, and the scope of the present disclosure, if adequately explained, is limited only by the appended claims as well as all the scopes equivalent to the appended claims. Like reference numerals in the drawings refer to the same or similar functions throughout several aspects.

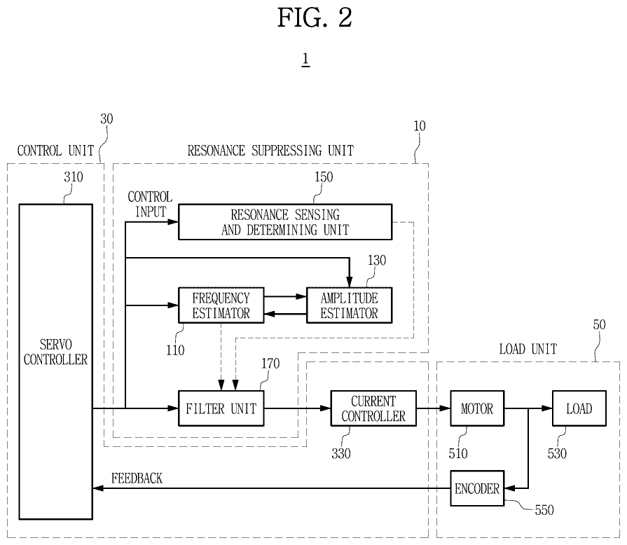

FIG. 2 is a block diagram of a servo system according to an embodiment of the present invention.

A servo system 1 according to the present invention includes a resonance suppressing unit 10 that automatically senses the resonance generated in the servo system 1 and suppresses the resonance, based on a frequency estimator 110 that uses the output of an amplitude estimator 130.

With reference to FIG. 2, the servo system 1 according to an embodiment of the present invention may include a control unit 30, the resonance suppressing unit 10, and a load unit 50.

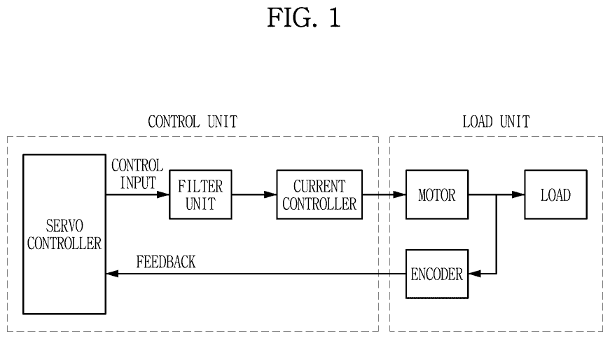

The control unit 30 may include a servo controller 310 and a current controller 330. The servo controller 310 and current controller 330 may perform the same functions as the servo controller and current controller described in FIG. 1. That is, the servo controller 310 generates a current command, and the current controller 330 generates a drive current according to the current command.

The load unit 50 may include a motor 510, a load 530, and an encoder 550. The functions of each constituent element may be the same as those of the motor, load, and encoder described in FIG. 1.

The resonance suppressing unit 10 includes the frequency estimator 110 and amplitude estimator 130, and senses and determines the resonance of the servo system 1 and suppresses the resonance.

The amplitude estimator 130 outputs an amplitude estimation value, which is a value obtained by estimation the amplitude of the resonance generated from the current command generated by the servo controller 310, and the frequency estimator 110 uses the amplitude estimation value to estimate the frequency of the resonance generated from the current command in real time, outputting the estimated frequency.

In another embodiment, the resonance suppressing unit 10 may further include at least one of a filter unit 170 or a resonance sensing and determining unit 150.

The frequency estimator 110 receives the current command as input and estimates the frequency of the current command in real time. To ensure that the outputted estimated frequency corresponds to the resonance frequency appearing in the current command, the frequency estimator 110 may continuously estimate the frequency of the current command by using the amount of change in the estimated frequency for the frequency of the current command during each operation cycle. For example, the frequency estimator 110 may estimate the frequency of the current command by integrating the small amount of change in the estimated frequency calculated in each operation cycle.

As the estimated frequency gets closer to the resonance frequency of the current command, the size of the small amount of change in the calculated estimated frequency becomes smaller, allowing the estimated frequency to converge to the resonance frequency of the input current command. Therefore, in the steady-state, the output of the frequency estimator 110 becomes the estimated frequency for the resonance frequency of the current command.

Before describing the frequency estimator 110 and amplitude estimator 130 according to an embodiment of the present invention, the conventional frequency estimator may be designed as an adaptive filter-based frequency estimator, as represented by Equation 1 below.

\ddot{x}+2ζ\hat{ω}\dot{x}+ω²x=2ζ\hat{ω}²u(t)

\dot{\hat{ω}}=−γ(\sqrt{(\hat{ω}x)²}−\sqrt{|x\ddot{x}|}) [Equation 1]

Here, X is the state of the adaptive filter, ζ is the damping factor of the adaptive filter, \hat{ω} is the estimated frequency, γ is the frequency estimation gain, and u(t) is the input signal, which in the present invention represents the current command.

The conventional frequency estimator calculates and integrates the small amount of change \dot{\hat{ω}} in the estimated frequency at every unit time, estimating the frequency of the input signal. When the magnitude (amplitude) of the input signal is A and the frequency is ω in a sinusoidal signal (u(t)=A sin ωt, the steady-state of the adaptive filter may be expressed by Equation 2 below.

x=A sin ωt

\dot{x}=Aω cos ωt

\ddot{x}=−Aω² sin ωt [Equation 2]

Substituting Equation 2 above into the equation for calculating the small amount of change in the estimated frequency in Equation 1 above, may be calculated as shown in Equation 3 below.

$$\begin{matrix}\dot{\hat{ω}} = - γ ( \sqrt{{( \hat{ω} A sin ω t )}^{2}} - \sqrt{\vert A sin ω t \cdot ( - A {ω}^{2} sin ω t ) \vert} ) \\ = - γ ( \vert \hat{ω} A sin ω t \vert - \vert A ωsinω t \vert ) \\ = - γ A ( \hat{ω} - ω ) \vert sin ω t \vert\end{matrix} \qquad [ Equation 3 ]$$

That is, the estimation velocity of the conventional frequency estimator expressed by Equation 1 has a characteristic proportional to the difference between the estimated frequency and the frequency of the input signal, as well as the magnitude of the input signal.

The conventional frequency estimator is designed so that the velocity at which it estimates the frequency does not fluctuate significantly depending on the frequency band of the input signal, and has been widely used for estimating the resonance frequency in industrial servo systems.

However, the frequency estimator has the disadvantage that the frequency estimation velocity varies depending on the magnitude of the input signal. Therefore, since the estimation velocity slows down when the magnitude of the input signal is small, there is a disadvantage that when a small resonance is generated, the frequency of the corresponding resonance is estimated slowly.

In actual servo systems, since various sizes of resonances may be generated, there is a need for the development of a frequency estimator whose estimation velocity does not vary depending on the magnitude of the input signal.

The frequency estimator 110 according to an embodiment of the present invention may alleviate the proportional relationship between the amplitude of the input signal and the estimation velocity by using the amplitude estimation value, which is the output value of the amplitude estimator 130 that estimates the amplitude of the resonance generated from the current command.

When the magnitude (amplitude) of the input signal is A and the frequency is @ in a sinusoidal signal (u(t)=A sin ωt), the amplitude estimator 130 may be designed as either Equation 4 or Equation 5 below.

However, the method of estimating the amplitude of the input signal is not limited to Equation 4 and Equation 5 below, and may be calculated using values that may be acquired in the servo system 1, such as the input signal, statistics of the input signal, and the state of the adaptive filter.

$$E ( u ( t ) ) = 0 \qquad [ Equation 4 ]$$

$$\begin{matrix}Var ( u ( t ) ) = E ( {u ( t )}^{2} ) - {( E ( u ( t ) ) )}^{2} \\ = \frac{1}{2 π} {\int }_{0}^{2 π} {A}^{2} {sin}^{2} ( ω t ) dt \\ = \frac{1}{2} {A}^{2}\end{matrix}$$

$$\hat{A} = \sqrt{2 \cdot Var ( u ( t ) )}$$

Here, E(u(t)) represents the expected value of the input signal, Var(u(t)) represents the variance of the input signal, and Â represents the amplitude estimation value of the input signal.

$$\begin{matrix}\hat{A} = \sqrt{{x}^{2} + {( \frac{\dot{x}}{\hat{ω}} )}^{2}} \\ = \sqrt{{( A sin ω t )}^{2} + {( \frac{A ωcosω t}{\hat{ω}} )}^{2}} \\ = A \sqrt{1 + {( \frac{ω - \hat{ω}}{\hat{ω}} )}^{2} {cos}^{2} ω t}\end{matrix} \qquad [ Equation 5 ]$$

Equation 4 above is a method of calculating the amplitude of the input signal using the input signal and statistics thereof. When applied to an actual servo system, since the variance needs to be calculated prior to a specific unit time up to the present, a time delay is inevitably generated. Additionally, depending on the sampling time, the expected value of the sinusoidal input signal may not become zero.

That is, since it is not possible to accurately calculate the amplitude value of the current time based on the time delay and sampling time, using the variance of the input signal as in Equation 4 above makes it difficult to obtain the precise amplitude of the input signal.

Equation 5 above is a method of estimating the amplitude of the input signal by using the state of the adaptive filter in the frequency estimator of Equation 1 above and the estimated frequency of the previous sample. By substituting the steady-state of the adaptive filter of the frequency estimator, expressed by Equation 2 above, into Equation 5 above, the amplitude estimation value in the steady-state may be calculated. The amplitude estimation value may vary in accuracy depending on the frequency of the input signal and the estimated frequency.

The frequency estimator 110 according to an embodiment of the present invention alleviates the estimation velocity of the conventional frequency estimator being proportional to the amplitude of the input signal by dividing the small amount of change in the estimated frequency by the amplitude estimation value when calculating the small amount of change in the estimated frequency.

The frequency estimator 110 according to an embodiment of the present invention may be designed as an adaptive filter and amplitude estimation value-based frequency estimator, expressed by Equation 6 below, by using the conventional frequency estimator expressed by Equation 1 above.

$$\ddot{x} + 2 ζ \hat{ω} \dot{x} + {\hat{ω}}^{2} x = 2 ζ {\hat{ω}}^{2} u ( t ) \qquad [ Equation 6 ]$$

$$\dot{\hat{ω}} = - γ \frac{( \sqrt{{( \hat{ω} x )}^{2}} - \sqrt{\vert x \ddot{x} \vert} )}{max ( \hat{A} , {A}_{min} )}$$

Here, Aₘᵢₙ is a threshold value set to prevent dividing the small amount of change in the estimated frequency in Equation 6 above by zero. It may be designed to divide the small amount of change in the estimated frequency by Aₘᵢₙ when the amplitude estimation value Â is smaller than Aₘᵢₙ, and divide the small amount of change in the estimated frequency by Â when the amplitude estimation value Â is greater than Aₘᵢₙ.

When the magnitude (amplitude) of the input signal is A and the frequency is @ in a sinusoidal signal (u(1)=A sin ωt), substituting Equation 2 and Equation 5 above into the small amount of change calculation equation of the estimated frequency in Equation 6 above results in Equation 7 below.

$$\dot{\hat{ω}} = - γ \frac{( \hat{ω} - ω ) \vert sin ω t \vert}{\sqrt{1 + {( \frac{ω - \hat{ω}}{\hat{ω}} )}^{2} {cos}^{2} ω t}} \qquad [ Equation 7 ]$$

When the frequency estimator is designed as in Equation 6 above, dividing Equation 3 above by the effect of the magnitude of the input signal may alleviate the characteristic of the estimation velocity of the frequency estimator in the conventional frequency estimator expressed by Equation 1 above being proportional to the magnitude of the input signal.

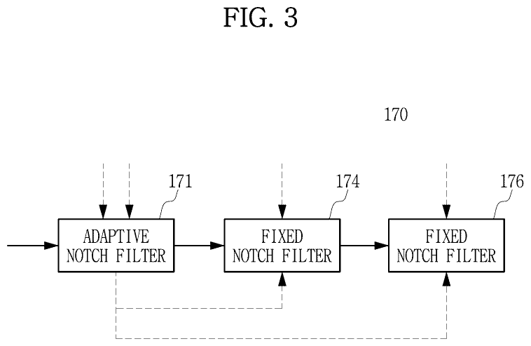

FIG. 3 is a block diagram illustrating an example of the filter unit in FIG. 2.

With reference to FIG. 3, the filter unit 170 may include an adaptive notch filter 171 and a plurality of fixed notch filters 174 and 176 connected in series. In FIG. 3, one adaptive notch filter and two fixed notch filters are illustrated, but the order and number are merely exemplary, and various other filters, such as low-pass filters for noise reduction, may also be further included.

Here, the adaptive notch filter 171 may filter the current command using the estimated frequency estimated by the frequency estimator 110 as a notch frequency, and provide the filtered current command to the current controller 330.

The adaptive notch filter 171 may be designed as a second-order notch filter, as expressed by Equation 8 below, but the present invention is not limited thereto.

$$H ( s ) = \frac{{s}^{2} + {\hat{ω}}^{2}}{{s}^{2} + 2 ζ \hat{ω} s + {\hat{ω}}^{2}} \qquad [ Equation 8 ]$$

Here, s represents the Laplace operator, \hat{ω}represents the notch frequency, and ζ represents the damping factor of the filter.

The notch frequency of the adaptive notch filter 171 may change over time as the estimated frequency of the frequency estimator 110.

The fixed notch filters 174 and 176 of the filter unit 170, upon determining that resonance has been suppressed using the adaptive notch filter 171 by the resonance sensing and determining unit 150, use the parameters of the adaptive notch filter 171, including the notch frequency, as the parameters for the fixed notch filters 174 and 176, and then fix those values.

The fixed notch filters 174 and 176 may be designed as a second-order notch filter, expressed by Equation 9 below, similar to Equation 8 above, but the present invention is not limited thereto.

$${H}_{NF} ( s ) = \frac{{s}^{2} + {ω}_{notch}^{2}}{{s}^{2} + 2 {ζ}_{notch} {ω}_{notch} s + {ω}_{notch}^{2}} \qquad [ Equation 9 ]$$

Here, ω_{notch} represents the notch frequency of the fixed notch filters 174 and 176, and ω_{notch} represents the damping factor of the fixed notch filters. The notch frequency and damping factor of the fixed notch filters 174 and 176 are values received from the adaptive notch filter when it is determined by the resonance sensing and determining unit 150 that resonance has been suppressed, and these values do not change over time.

The resonance sensing and determining unit 150 according to an embodiment of the present invention receives the current command generated by the servo controller 310 as an input signal and may sense whether the resonance of the servo system is generated, whether the resonance of the servo system is suppressed, and the magnitude of the resonance from the current command. That is, the resonance sensing and determining unit 150 may determine whether the resonance of the load unit 50 is generated and suppressed, from the current command generated based on the signal feedback from the encoder.

The resonance sensing and determining unit 150 may be designed to determine whether to apply the estimated frequency to the adaptive notch filter 171, when these values exceed a specific threshold value, by using values, such as the current command and statistics thereof, which may be obtained from the servo system 1, which may determine resonance generation in the servo system 1.

Additionally, the resonance sensing and determining unit 150 may be designed to determine that the resonance has been suppressed using the adaptive notch filter 171, and set the parameters of the adaptive notch filter 171 as the parameters of the fixed notch filters 174 and 176, and fix those values, when determining that the resonance has been suppressed.

After setting the fixed notch filters 174 and 176, the resonance sensing and determining unit 150 may be designed to repeatedly operate the processes of determining whether a new resonance is generated setting the notch frequency of the adaptive notch filter as the estimated frequency of the new resonance, determining the suppression of the new resonance, and setting the parameters of fixed notch filters other than the fixed notch filter set before the new resonance is generated.

The resonance sensing and determining unit 150 may be designed to store the magnitude of the resonance using values that determine the resonance generation and, when all the plurality of fixed notch filters 174 and 176 are in use and a new resonance is generated, compare the magnitude of the newly generated resonance with the resonance magnitudes before setting the parameter of each fixed notch filter to determine whether to replace the fixed notch filter.

The resonance sensing and determining unit 150 may be designed so that when all the plurality of fixed notch filters 174 and 176 are in use and the magnitude of the newly generated resonance is smaller than the resonance before setting the parameter of each fixed notch filter, no separate operation is performed.

When the magnitude of the newly generated resonance is greater than the resonance before setting the parameter of any fixed notch filter, it may be designed that the adaptive notch filter 171 is operated to determine whether the resonance is suppressed, and when it is determined that the resonance has been suppressed, the parameters of the fixed notch filter with the smaller resonance magnitude is replaced and fixed with the parameters of the adaptive notch filter 171.

In this case, when it is not determined that the resonance has been suppressed, it may be designed that the existing fixed notch filter continues to be used. The resonance sensing and determining unit 150 may be designed to repeat the above process when all the plurality of fixed notch filters 174 and 176 are in use, to replace and maintain the fixed notch filter.

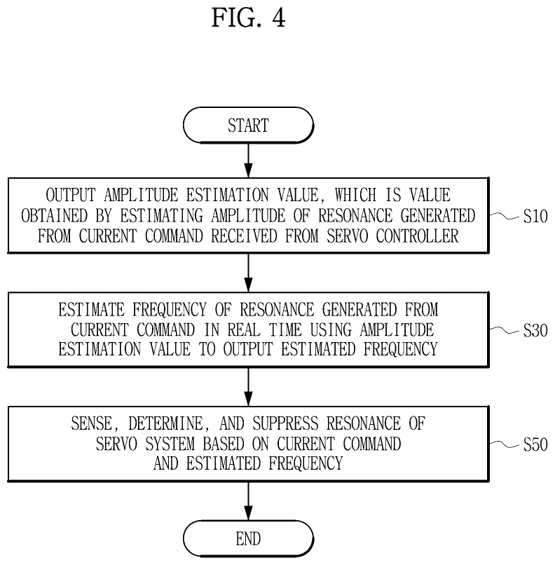

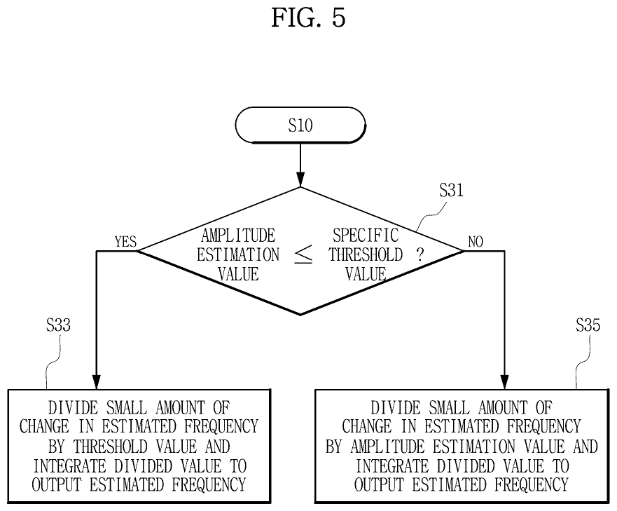

FIG. 4 is a flowchart illustrating a method of suppressing resonance of a servo system according to an embodiment of the present invention. FIG. 5 is a flowchart illustrating the step of estimating the frequency in real time in FIG. 4.

The method of suppressing resonance of the servo system according to this embodiment may be carried out in a configuration that is essentially the same as the resonance suppressing unit 10 of the servo system 1 in FIG. 2. Therefore, the constituent elements that are the same as those in the resonance suppressing unit 10 in FIG. 2 are assigned the same reference numerals, and repeated descriptions are omitted.

Additionally, the method of suppressing resonance of the servo system according to this embodiment may be executed by software (application) for performing resonance suppression of the servo system.

With reference to FIG. 4, the method of suppressing resonance of the servo system may include the steps of calculating an amplitude estimation value of the resonance generated from a current command generated by the servo controller (step S10), estimating the frequency of the resonance generated from the current command in real time based on the amplitude estimation value (step S30), and sensing, determining, and suppressing the resonance of the servo system using the current command and the estimated frequency (step S50).

In an embodiment, the amplitude estimation step (step S10) may estimate the amplitude of the resonance generated from the current command by using the adaptive filter state, the estimated frequency of previous samples, the current command, the statistics of the current command, and other relevant values.

In an embodiment, the frequency estimation step (step S30) may estimate the frequency of the input signal by using the current command, the amplitude estimation value, the adaptive filter state, and the estimated frequency of previous samples. Here, the small amount of change in the estimated frequency may be divided by the amplitude estimation value, and by integrating this, the estimated frequency may be output.

With reference to FIG. 5, to prevent division by zero when dividing by the amplitude estimation value, it is first determined whether the amplitude estimation value is equal to or less than a preset specific threshold value (step S31).

When the amplitude estimation value is equal to or less than the specific threshold value, the small amount of change in the estimated frequency is divided by the threshold value (step S33). When the amplitude estimation value exceeds the threshold value, the small amount of change in the estimated frequency may be calculated by being divided by the amplitude estimation value (step S35).

In an embodiment, the step of sensing, determining, and suppressing the resonance of the servo system (step S50) may further include a filtering step, and a resonance sensing and determining step.

Here, the filtering step further includes an adaptive notch filter and a plurality of fixed notch filters, which filter the current command using the estimated frequency as a notch frequency. When resonance suppression is confirmed with the adaptive notch filter, the fixed notch filter uses the parameters of the adaptive notch filter, including the notch frequency as the filter parameters of the fixed notch filter, and fixes those values.

Additionally, the resonance sensing and determining step may include determining whether the resonance of the servo system is generated, the magnitude of the resonance, and whether the resonance is suppressed by using the current command, then determining whether to use the adaptive notch filter, whether to switch parameters to the fixed notch filter, and determining whether to replace the fixed notch filter by comparing the magnitude of the newly generated resonance with the resonance magnitudes before each fixed notch filter is applied when all the plurality of fixed notch filters are in use and a new resonance is generated.

The method of suppressing resonance of the servo system, as described, may be implemented as an application or in the form of program instructions that may be performed through various computer constituent elements, and these instructions may be recorded on a computer-readable recording medium. The computer-readable recording medium may include program instructions, data files, data structures, or the like, in a stand-alone form or in a combination thereof.

The program instructions recorded in the computer-readable recording medium may be designed and configured specifically for the present invention or may be publicly known and available to those skilled in the field of computer software.

Examples of the computer-readable recording medium may include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions.

Examples of the program instructions include machine codes made by a compiler, as well as high-language codes that may be executed by a computer, using an interpreter. The above hardware devices may be configured to operate as one or more software modules in order to perform the operation according to the present invention, and vice versa.

While the present invention has been described above with reference to the embodiments, it may be understood by those skilled in the art that the present invention may be variously modified and changed without departing from the spirit and scope of the present invention disclosed in the claims.

### DESCRIPTION OF REFERENCE NUMERALS

1: Servo system
10: Resonance suppressing unit
110: Frequency estimator
130: Amplitude estimator
150: Resonance sensing and determining unit
170: Filter unit
30: Control unit
310: Servo controller
330: Current controller
50: Load unit
510: Motor
530: Load
550: Encoder
171: Adaptive notch filter
174 and 176: Fixed notch filter

1. An apparatus for suppressing resonance in a servo system, comprising:
a resonance suppressing unit comprising:
an amplitude estimator configured to output an amplitude estimation value, the amplitude estimation value being a value obtained by estimating an amplitude of resonance generated from a current command received from a servo controller; and
a frequency estimator configured to estimate, in real time, a frequency of the resonance generated from the current command using the amplitude estimation value, and to output an estimated frequency,
wherein the resonance suppressing unit is configured to sense, determine, and suppress resonance in the servo system based on the current command and the estimated frequency.

2. The apparatus of claim 1, wherein the amplitude estimator estimates the amplitude of the resonance generated from the current command by using at least one of an adaptive filter state of the frequency estimator, an estimated frequency of previous samples, the current command, or statistics of the current command.

3. The apparatus of claim 1, wherein the frequency estimator estimates the frequency of the current command, which is an input signal, by using at least one of the current command, the amplitude estimation value, an adaptive filter state, or an estimated frequency of previous samples.

4. The apparatus of claim 3, wherein the frequency estimator divides a small amount of change in the estimated frequency by the amplitude estimation value and integrates the divided value to output an estimated frequency.

5. The apparatus of claim 4, wherein the frequency estimator divides the small amount of change in the estimated frequency by a specific threshold value when the amplitude estimation value is equal to or less than the specific threshold value, and divides the small amount of change in the estimated frequency by the amplitude estimation value when the amplitude estimation value exceeds the specific threshold value.

6. The apparatus of claim 1, wherein the resonance suppressing unit further comprises at least one of a filter unit or a resonance sensing and determining unit.

7. The apparatus of claim 6, wherein the filter unit further
comprises an adaptive notch filter and a plurality of fixed notch filters that filter the current command using the estimated frequency as a notch frequency, and
wherein a fixed notch filter from the plurality of fixed notch filters uses parameters of the adaptive notch filter, including the notch frequency, as filter parameters of the fixed notch filter when resonance suppression is confirmed with the adaptive notch filter, and fixes values of the filter parameters of the fixed notch filter.

8. The apparatus of claim 6, wherein the resonance sensing and determining unit determines whether the resonance of the servo system is generated, a magnitude of the resonance, and whether the resonance is suppressed by using the current command, and then determines whether to use an adaptive notch filter, whether to switch parameters to a fixed notch filter, and when a plurality of fixed notch filters are all in use and a new resonance is generated, compares a magnitude of the newly generated resonance with resonance magnitudes before each fixed notch filter is applied to determine whether to replace the fixed notch filter.

9. A method of suppressing resonance of a servo system, comprising:
an amplitude estimation step of outputting an amplitude estimation value, which is an value obtained by estimating an amplitude of resonance generated from a current command received from a servo controller;
a frequency estimation step of estimating a frequency of the resonance generated from the current command in real time to output an estimated frequency by using the amplitude estimation value; and
a resonance suppressing step of sensing, determining, and suppressing resonance of the servo system based on the current command and the estimated frequency.

10. The method of claim 9, wherein the amplitude estimation step comprises estimating the amplitude of the resonance generated from the current command by using at least one of an adaptive filter state, an estimated frequency of previous samples, the current command, or statistics of the current command.

11. The method of claim 9, wherein the frequency estimation step comprises estimating the frequency of the current command, which is an input signal, by using at least one of the current command, the amplitude estimation value, an adaptive filter state, or an estimated frequency of previous samples.

12. The method of claim 11, wherein the frequency estimation step further comprises dividing a small amount of change in the estimated frequency by the amplitude estimation value and integrates the divided value to output an estimated frequency.

13. The method of claim 12, wherein the frequency estimation step comprises dividing the small amount of change in the estimated frequency by a specific threshold value when the amplitude estimation value is equal to or less than the specific threshold value, and dividing the small amount of change in the estimated frequency by the amplitude estimation value when the amplitude estimation value exceeds the specific threshold value.

14. The method of claim 9 wherein the resonance suppressing step further comprises at least one of a filtering step or a resonance sensing and determining step.

15. The method of claim 14, wherein the filtering step comprises filtering the current command using an adaptive notch filter and a plurality of fixed notch filters, with the estimated frequency being used as a notch frequency, and
wherein a fixed notch filter from the plurality of fixed notch filters uses parameters of the adaptive notch filter, including the notch frequency, as filter parameters of the fixed notch filter when resonance suppression is confirmed with the adaptive notch filter, and fixes values of the filter parameters of the fixed notch filter.

16. The method of claim 14, wherein the resonance sensing and determining step comprises:
determining whether the resonance of the servo system is generated, a magnitude of the resonance, and whether the resonance is suppressed by using the current command; and
determining whether to use an adaptive notch filter, whether to switch parameters to a fixed notch filter, and whether to replace the fixed notch filter by comparing a magnitude of a newly generated resonance with resonance magnitudes before each fixed notch filter is applied when a plurality of fixed notch filters are all in use and the new resonance is generated.

17. A computer program stored on a non-transitory computer-readable storage medium to execute the method of suppressing resonance of the servo system according to claim 9 in combination with hardware.
